(19) United States
(12) Patent Application Publication
(10) Pub. No.: US 2026/0330855 A1
(43) Pub. Date: Oct. 22, 2026

(54) SYSTEMS AND METHODS FOR ONBOARDING A VEHICLE

(71) Applicant: Ford Global Technologies, LLC, Dearborn, MI (US)

(72) Inventors: Krishna Bandi, Novi, MI (US); Ryan O'Gorman, Beverly Hills, MI (US); Stuart C. Salter, White Lake, MI (US); Brendan Diamond, Naples, FL (US); Vyas Darshan Shenoy, Canton, MI (US)

(73) Assignee: Ford Global Technologies, LLC, Dearborn, MI (US)

(21) Appl. No.: 19/180,909

(22) Filed: Apr. 16, 2025

(51) Int. Cl. G06V 20/00; G06V 10/74; G06V 20/17; H04W 4/021

(52) U.S. Cl. CPC G06V 20/95; G06V 10/74; G06V 20/17; H04W 4/021; G06V 2201/08

(57) ABSTRACT

A method includes the receipt of an identification pattern from an infrastructure system, the determination of whether the vehicle is located within a distance-related threshold from the infrastructure system, and the performance of one or more actions corresponding to the identification pattern in response to determining that the vehicle is located within the distance-related threshold from the infrastructure system.

### FIELD

The present disclosure relates to onboarding a vehicle, and more particularly, onboarding a vehicle based on a uniquely assigned identification pattern.

### BACKGROUND

The statements in this section merely provide background information related to the present disclosure and may not constitute prior art.

Typically utilized methods for onboarding a vehicle implement challenges for identifying a vehicle, such as a blinking challenge. However, a plant marshaling system relying on the blinking challenge to onboard vehicles cannot disable certain light functions enabled by a human operator as per certain standards. Other issues related to typically utilized blinking challenges can include a lack of customization and false onboarding due to a server misinterpreting a blinking pattern performed by a vehicle.

The present disclosure addresses these and other issues related to the onboarding of a vehicle.

### SUMMARY

This section provides a general summary of the disclosure and is not a comprehensive disclosure of its full scope or all of its features.

The present disclosure provides a method for onboarding a vehicle, the method comprising: receiving, at the vehicle, an identification pattern from an infrastructure system; determining whether the vehicle is located within a distance-related threshold from the infrastructure system; and performing one or more actions corresponding to the identification pattern in response to determining that the vehicle is located within the distance-related threshold from the infrastructure system; wherein the identification pattern includes a light pattern, a vehicle movement, a window movement, a door movement, a hatch movement, an audio pattern, or a combination thereof; wherein the identification pattern is specific to the vehicle; wherein determining whether the vehicle is located within the distance-related threshold from the infrastructure system further comprises: performing one or more localization techniques based on a predetermined geofenced-based mapping of a marshaling environment; further comprising: causing, based on performing the one or more localization techniques, one or more drones to be deployed to the location of the vehicle in response to determining that the vehicle is located outside of the distance-related threshold from the infrastructure system; and performing the one or more actions in response to the one or more drones being deployed to the location of the vehicle; and further comprising: performing one or more additional actions to confirm a successful onboarding event associated with the vehicle, wherein the one or more additional actions are different than the one or more actions.

The present disclosure provides another method for onboarding a vehicle, the method comprising: assigning, to the vehicle, an identification pattern in response to receiving an onboarding request from the vehicle; transmitting the identification pattern to the vehicle; confirming an identity of the vehicle based on determining that the vehicle is located within a distance-related threshold from an infrastructure system and a performance of one or more actions matching the identification pattern, wherein the one or more actions are performed by the vehicle in response to receiving the identification pattern; and onboarding the vehicle in response to confirming the identity of the vehicle; wherein the identification pattern includes a light pattern, a vehicle movement, a window movement, a door movement, a hatch movement, an audio pattern, or a combination thereof; wherein the identification pattern is specific to the vehicle; further comprising: receiving, from the vehicle, one or more messages indicating that the vehicle is located outside of the distance-related threshold from the infrastructure system; and deploying one or more drones to a location of the vehicle in response to receiving the one or more messages; further comprising: receiving a video stream from the one or more drones; performing one or more image recognition techniques in response to receiving the video stream; and determining whether the one or more actions match the identification pattern in response to performing the one or more image recognition techniques; and further comprising: performing one or more image recognition techniques based on a field of view of one or more sensors of the infrastructure system; and determining whether the one or more actions match the identification pattern in response to performing the one or more image recognition techniques.

The present disclosure provides a system for onboarding a vehicle, the system comprising: a vehicle system configured to: transmit an onboarding request, receive an identification pattern specific to the vehicle, determine whether the vehicle associated with the vehicle system is located within a distance-related threshold from an infrastructure system, and perform one or more actions corresponding to the identification pattern in response to determining that the vehicle is located within the distance-related threshold from the infrastructure system; and the infrastructure system configured to: assign the identification pattern to the vehicle in response to receiving the onboarding request, transmit the identification pattern, confirm an identity of the vehicle based on the performance of the one or more actions matching the identification pattern, and onboard the vehicle in response to confirming the identity of the vehicle; wherein the identification pattern includes a light pattern, a vehicle movement, a window movement, a door movement, a hatch movement, an audio pattern, or a combination thereof; wherein the vehicle system configured to determine whether the vehicle is located within the distance-related threshold from the infrastructure system is further configured to: perform one or more localization techniques based on a predetermined geofenced-based mapping of a marshaling environment; wherein the vehicle system is further configured to: cause, based on the performance of the one or more localization techniques, one or more drones to be deployed to the location of the vehicle in response to determining that the vehicle is located outside of the distance-related threshold from the infrastructure system; and perform the one or more actions in response to the one or more drones being deployed to the location of the vehicle; wherein the infrastructure system is further configured to: receive, from the vehicle system, one or more messages indicating that the vehicle is located outside of the distance-related threshold from the infrastructure system; and deploy one or more drones to a location of the vehicle in response to receiving the one or more messages; wherein the infrastructure system is further configured to: receive a video stream from the one or more drones; perform one or more image recognition techniques in response to the receipt of the video stream; and determine whether the one or more actions match the identification pattern in response to the performance of the one or more image recognition techniques; wherein the infrastructure system is further configured to: perform one or more image recognition techniques based on a field of view of one or more sensors of the infrastructure system; and determine whether the one or more actions match the identification pattern in response to the performance of the one or more image recognition techniques; and wherein the vehicle system is further configured to: perform one or more additional actions to confirm a successful onboarding event associated with the vehicle, wherein the one or more additional actions are different than the one or more actions.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 illustrates an implementation of a system for onboarding a vehicle in accordance with one or more embodiments of the present disclosure;

FIG. 4 is a flowchart illustrating an example method for onboarding a vehicle in accordance with one or more embodiments of the present disclosure;

FIG. 5 is a flowchart illustrating another example method for onboarding a vehicle in accordance with one or more embodiments of the present disclosure;

FIG. 6 is a flowchart illustrating yet another example method for onboarding a vehicle in accordance with one or more embodiments of the present disclosure;

FIG. 7 is a flowchart illustrating a further example method for onboarding a vehicle in accordance with one or more embodiments of the present disclosure; and

FIG. 8 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for an enhanced means for onboarding a vehicle. In one or more examples, the onboarding processes disclosed herein enhances accuracy in onboarding the vehicle by reducing delays in production cycle times; preventing the loading/unloading of a wrong vehicle; preventing incorrect vehicle control and/or parking the vehicle in a wrong parking spot; and/or preventing positioning the vehicle in a wrong charging location. Additional advantages provided by the onboarding processes disclosed herein affords for an unlimited number of vehicles to be accurately onboarded at any distance from a central server and in any condition(s).

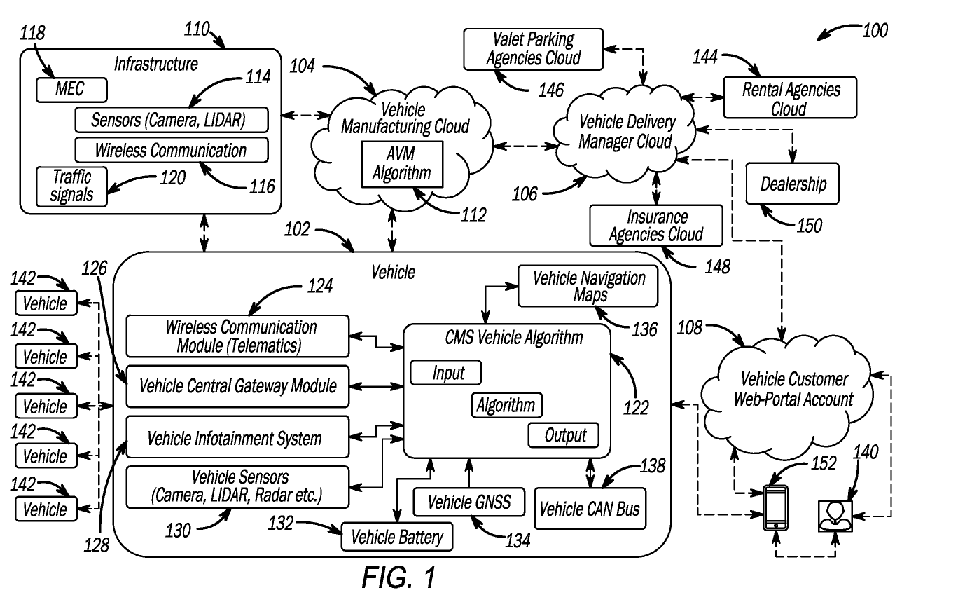

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

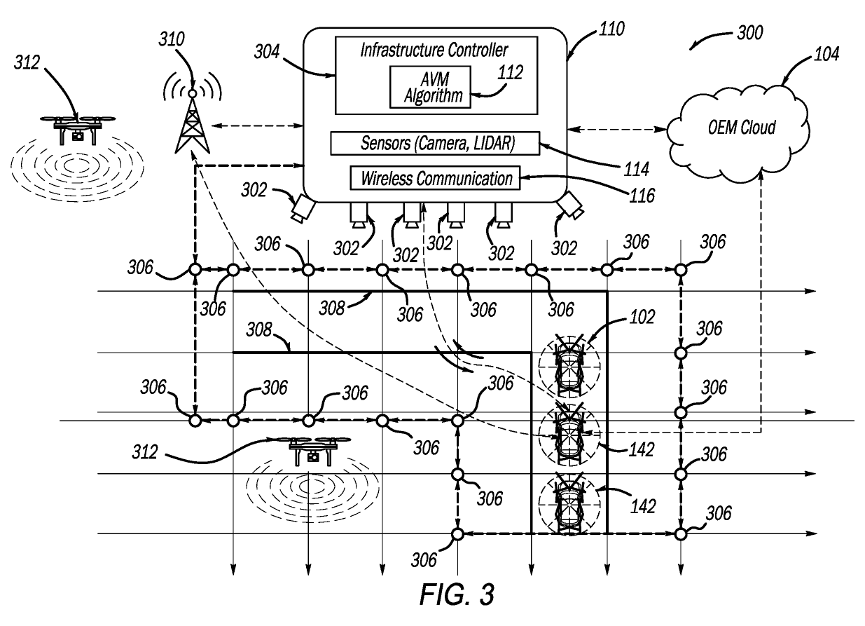

The vehicle manufacturing cloud system 104 can include an infrastructure-side AVM algorithm 112. However, it is understood that the infrastructure system 110 can include the infrastructure-side AVM algorithm 112 as well, as is shown in FIG. 3. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment. For example, the marshaling environment can represent a plant marshaling setting, an automated charging setting, a depot marshaling setting, a parking setting, among others. As an example, the plant marshaling setting can include an instance wherein just-built vehicles are moved through end-of-line testing at a vehicle assembly plant via overhead vision sensing (e.g., via a set of infrastructure sensors 302 as shown in FIG. 3). As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is also configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. It is understood that the MEC system 118 is configured to support communication between the wireless communication component 116 and the vehicle 102. It is further understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth^{®} to communicate with the one or more vehicles.

The wireless communication component 116 also communicates with the sensor component 114 that is configured to communicate with and/or manage the set of infrastructure sensors 302, as is described herein. In one or more examples, the sensor component 114 is also configured to perform one or more localization functions associated with marshaling the one or more vehicles such as, but not limited to, perception, path-planning, detection, controls, and/or receiving and analyzing response(s) from each vehicle of the one or more vehicles.

The wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include, but is not limited to, a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits a wall or another vehicle and is then reflected back to the vehicle 102. Based on the amount of time it takes for the sound wave to return to the vehicle 102, the vehicle 102 can determine the distance between the one or more vehicle sensors 130 and the wall or the other vehicle. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the wall or the other vehicle and is then reflected back to the vehicle 102. Based on the amount of time it takes for the electromagnetic waves to return to the vehicle 102, the vehicle 102 can determine a range, velocity, and angle of the vehicle 102 relative to the wall or the other vehicle.

The one or more vehicle sensors 130 communicate information associated with the position and/or distance at which the vehicle 102 is located relative to the wall or the other vehicle to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as, but not limited to, the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agency cloud system 144, a valet parking agency cloud system 146, an insurance agency cloud system 148, and/or a dealership system 150. The vehicle delivery manager cloud system 106 is configured to facilitate the delivery of the one or more vehicles to, for example, any of a rental agency (not shown) associated with the rental agency cloud system 144, a valet parking agency (not shown) associated with the valet parking agency cloud system 146, an insurance agency (not shown) associated with the insurance agency cloud system 148, and/or the dealership system 150. The vehicle delivery manager cloud system 106 also wirelessly communicates with the vehicle customer web-portal account cloud system 108. It should be understood that other cloud systems can be included, in one or more examples.

The vehicle delivery manager cloud system 106 wirelessly communicates with a user device 152 such as, but not limited to, a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agency cloud system 144, the valet parking agency associated with the valet parking agency cloud system 146, the insurance agency associated with the insurance agency cloud system 148, and/or the dealership system 150.

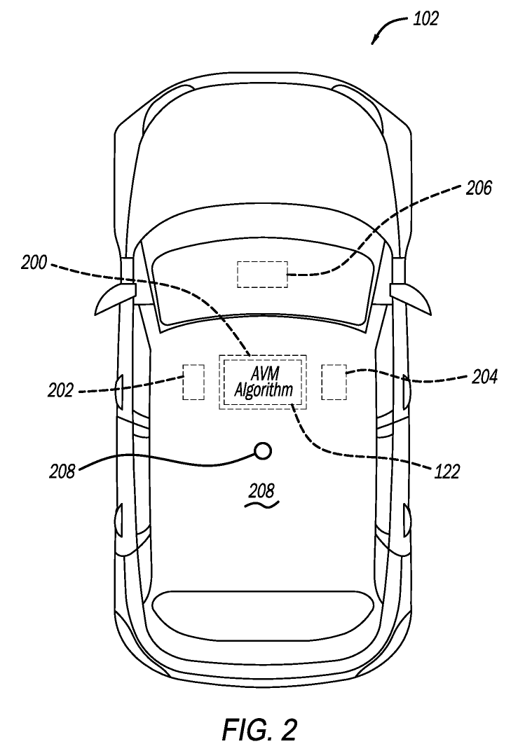

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes a vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The plurality of on-board sensors 204 includes a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensor(s) affixed to one or more bumpers of the vehicle(s) 102 that may provide locations of the object(s) relative to the location of each of the vehicle(s) 102. As yet another example, one or more of the plurality of on-board sensors 204 can be configured to monitor one or more functionalities associated with one or more internally-based components of the vehicle(s) 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be programmed to determine a current vehicle location based on location coordinates (e.g., GPS coordinates) received from the vehicle(s) 102 indicative of a location of the vehicle(s) 102 from a GPS sensor (not shown).

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programmed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for various communications on a vehicle communication network (not shown) that can include a bus in the vehicle(s) 102 such as a CAN bus, or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as is discussed below, various other controllers and/or sensors provide data to the vehicle controller 200 via the vehicle communication network.

In addition, the vehicle controller 200, via the vehicle-side AVM algorithm 122, is also configured to communicate through a vehicle-to-infrastructure communication network, such as communicating with an infrastructure controller (e.g., an infrastructure controller 304 as shown in FIG. 3). The vehicle controller 200, via the vehicle-side AVM algorithm 122, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The HMI 206 is configured to receive information from the human operator during operation of the vehicle(s) 102. Moreover, the HMI 206 is configured to present information to the human operator, such as an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

In one or more embodiments, FIG. 3 shows a system 300 configured to provide a means for onboarding the vehicle 102 (e.g., and/or the one or more additional vehicles 142). More specifically, onboarding the vehicle 102 (e.g., and/or the one or more additional vehicles 142) within the bounds offered by the system 300 provides an enhanced means for accurately onboarding the vehicle 102 (e.g., and/or the one or more additional vehicles 142).

In one or more embodiments, the infrastructure system 110 includes the sensor component 114 that communicates with the set of infrastructure sensors 302. The set of infrastructure sensors 302 are configured to monitor the movement of the vehicle 102 (e.g., and/or the one or more additional vehicles 142) as the vehicle 102 (e.g., and/or the one or more additional vehicles 142) moves through the marshaling environment. The infrastructure system 110 also includes the wireless communication component 116 that provides a means for communication between the infrastructure system 110 and at least one communication node 310 as well as the vehicle manufacturing cloud system 104. However, it is understood that the wireless communication component 116 also provides a means for direct communication between the infrastructure system 110 and the vehicle 102 (e.g., and/or the one or more additional vehicles 142).

In one or more examples, movement of the vehicle 102 (e.g., and/or the one or more additional vehicles 142) through the manufacturing environment is monitored based on a field of view of the set of infrastructure sensors 302. As another example, movement of the vehicle 102 (e.g., and/or the one or more additional vehicles 142) through a geofenced area (e.g., a geofenced area 308 area as shown in FIG. 3) the manufacturing environment is also monitored based on one or more infrastructure marshaling messages (e.g., IMMs) and one or more vehicle marshaling messages (e.g., VMMs) exchanged between the vehicle 102 (e.g., and/or the one or more additional vehicles 142) and the infrastructure system 110.

Additionally, the infrastructure system 110 includes the infrastructure controller 304. The infrastructure controller 304 is configured to centrally control an operation of the vehicle 102 (e.g., and/or the one or more additional vehicles 142). For example, the operation of the vehicle 102 (e.g., and/or the one or more additional vehicles 142) includes propulsion, braking, and/or steering of the vehicle 102 (e.g., and/or the one or more additional vehicles 142). It is understood that the infrastructure controller 304 may be disposed within the infrastructure system 110 or externally located relative to the infrastructure system 110. The infrastructure controller 304 includes the infrastructure-side AVM algorithm 112 that is configured to facilitate communication between the infrastructure controller 304 and the vehicle controller 200 associated with the vehicle 102 (e.g., and/or the one or more additional vehicles 142).

The infrastructure-side AVM algorithm 112 is also configured to facilitate communication between the infrastructure controller 304 and one or more anchors 306. For example, each of the one or more anchors 306 can be a transceiver configured to transmit and/or receive any communication-related messages (e.g., instructions, signals, etc.). As an example, the infrastructure controller 304 and the one or more anchors 306 are communicatively coupled by a wired means. As another example, each of the one or more anchors 306 are also communicatively coupled to one another by a wired means. However, it is understood that the one or more anchors 306 may be wirelessly coupled to one another and/or the infrastructure controller 304. For example, the one or more anchors 306 may be positioned throughout the marshaling environment at any distance from one another. As another example, the one or more anchors 306 may be embedded within the floor of the marshaling environment. However, it is understood that the one or more anchors 306 may be disposed atop (e.g., on a surface of and not embedded within) the floor of the marshaling environment as well. It is additionally understood that the one or more anchors 306 may be disposed in a variety of ways such as, but not limited to, some of the one or more anchors 306 embedded within the floor of the marshaling environment and some of the one or more anchors 306 disposed atop the floor of the marshaling environment.

In one or more embodiments, the infrastructure-side AVM algorithm 112 is configured to receive an onboarding request from the vehicle 102 (e.g., and/or each of the one or more additional vehicles 142). In one or more examples, the infrastructure-side AVM algorithm 112 is also configured to generate and assign a custom vehicle-specific identification pattern to each vehicle wherefrom the onboarding request was received. In other words, and as an example, the vehicle-specific identification pattern uniquely assigned to the vehicle 102 is different from each additional vehicle of the one or more additional vehicles 142 or any other vehicle. As another example, the vehicle-specific identification pattern can include a light pattern, a vehicle movement, a window movement, a door movement, a hatch movement, an audio pattern, or a combination thereof. As yet another example, the assignment of different identification patterns to different vehicles enhances onboarding accuracy by reducing accidental onboarding of vehicles.

In one or more examples, a light pattern corresponding to the vehicle-specific identification pattern can be customized so that the vehicle 102 (e.g., or the one or more additional vehicles 142) may emit a specific light color from various and/or specific lighting mechanisms of the vehicle 102 (e.g., or the one or more additional vehicles 142) such as, but not limited to, brake lights, headlights, and/or side lights. As another example, the light pattern can also be customized so that the vehicle 102 (e.g., or the one or more additional vehicles 142) may emit light for any duration and/or frequency (e.g., such as a sequence of blinking lights). As yet another example, each of the lighting mechanisms of the vehicle 102 (e.g., or the one or more additional vehicles 142) are configured to simultaneously emit the same light color or different light colors at different times, at different durations, and/or at any frequency.

In one or more examples, the vehicle-specific identification pattern can also be customized to so that the vehicle 102 (e.g., or the one or more additional vehicles 142) can perform at least one of a vehicle movement, a window movement, a door movement, a hatch movement, and/or an audio pattern corresponding to the vehicle-specific identification pattern. As another example, the vehicle movement can include any precise movement of the vehicle 102 (e.g., or the one or more additional vehicles 142) such as, but not limited to, moving a particular distance (e.g., 2 feet versus 5 feet) and/or in any direction (e.g., 2 feet Northeast versus 3 feet North). As yet another example, each of the window movement, the door movement, and the hatch movement can include any movement (e.g., or pattern of movement) such as opening and closing any of the window(s), the door(s), and/or the hatch at any various degrees. As a further example, the audio pattern can include the emission of any sound pattern originating from any transducer of the vehicle (e.g., or the one or more additional vehicles 142).

It is understood that the vehicle-specific identification pattern can further be customized in relation to any functionality related to the vehicle 102 (e.g., or the one or more additional vehicles 142) such as, but not limited to, an activation of wiper blades of the vehicle 102 (e.g., or the one or more additional vehicles 142) and/or an activation of a washer pump of the vehicle 102 (e.g., or the one or more additional vehicles 142). In one or more examples, the infrastructure-side AVM algorithm 112 is configured to determine whether the vehicle 102 (e.g., or the one or more additional vehicles 142) is covered by rain, snow, dirt, or any other occlusion, which may be the basis for causing the vehicle 102 (e.g., or the one or more additional vehicles 142) to perform the vehicle-specific identification pattern related to the activation of wiper blades or any other action.

In one or more examples, the infrastructure system 110 is configured to transmit the vehicle-specific identification pattern in response to assigning the vehicle-specific identification pattern to each vehicle wherefrom the onboarding request was received.

Upon receipt of the vehicle-specific identification pattern, the vehicle-side AVM algorithm 122 is configured to perform one or more localization techniques to determine whether the vehicle 102 (e.g., and/or the one or more additional vehicles 142) is located within a distance-related threshold from the infrastructure system 110. In one or more examples, the distance-related threshold can be any predefined distance from the infrastructure system 110 that corresponds to a field of view of the one or more sensors 302 and/or a communicative range from the infrastructure system 110 (e.g., or the at least one communication node 310). As another example, the distance-related threshold can be one or more predefined identification locations corresponding to areas within range of the field of view of the one or more sensors 302 and/or the communicative range from the infrastructure system 110 (e.g., or the at least one communication node 301). As yet another example, the identification locations can be predefined by implementing geofenced-based mapping related to the geofenced area 308. It is understood that the geofenced-based mapping can dynamically adjust and be dependent on one or more environmental conditions or any other condition that may affect at least the field of view of the one or more sensors 302.

In one or more examples, the one or more localization techniques can be based a utilization of the one or more anchors 306 and/or the geofenced-based mapping related to the geofenced area 308. As another example, the one or more localization techniques can include, but are not limited to, signal triangulation, GPS signaling, and map-matching algorithms.

In one or more examples, the vehicle 102 (e.g., and/or the one or more additional vehicles 142) is configured to perform one or more actions corresponding to the vehicle-specific identification pattern in response to the vehicle-side AVM algorithm 122 determining that the vehicle 102 (e.g., and/or the one or more additional vehicles 142) is located within the distance-related threshold from the infrastructure system 110. As another example, the one or more actions can include, but is not limited to, the light pattern, the vehicle movement, the window movement, the door movement, the hatch movement, the audio pattern, and/or any other function-related pattern associated with the vehicle 102 (e.g., and/or the one or more additional vehicles). It is understood that different actions of the one or more actions may be performed based on the location of the vehicle 102 (e.g., and/or the one or more additional vehicles 142), which ensures that the performance of the one or more actions can be detected by at least the one or more sensors 302.

In one or more examples, and in a case wherein the vehicle-side AVM algorithm 122 and/or the infrastructure-side AVM algorithm 112 determines that the vehicle 102 (e.g., and/or the one or more additional vehicles 142) is located outside of the distance-related threshold from the infrastructure system 110, the infrastructure-side AVM algorithm 112 is configured to deploy one or more drones 312 to the location of the vehicle 102 (e.g., and/or the one or more additional vehicles 142). It is understood that a number of drones deployed by the infrastructure system can be proportional (e.g., based on any ratio) to a number of vehicles to be controlled autonomously by the infrastructure system 110, which prevents authorization bottlenecks in the onboarding process. It is also understood that the one or more drones 312 are configured to confirm multiple vehicles at a time, wherein an order of confirmation can depend on a priority-listing indicating a desired order of confirmation and/or a prediction (e.g., performed by the infrastructure-side AVM algorithm 11) of a movement of the vehicle 102 (e.g., and/or the one or more additional vehicles 142)

For example, the one or more drones 312 are configured to calibrate a location(s) associated with the vehicle 102 (e.g., and/or the one or more additional vehicles 142) based on one or more datum points and/or the one or more anchors 306. As another example, the one or more drones 312 are also configured to recalibrate the location(s) associated with the vehicle 102 (e.g., and/or the one or more additional vehicles 142) based on the one or more datum points and/or the one or more anchors 306 in relation to the infrastructure system 110 and a location that may be within the distance-related threshold.

In one or more examples, in the instance wherein the vehicle 102 (e.g., or the one or more additional vehicles 142) is located within the distance-related threshold, the infrastructure system 110 is configured to confirm an identity (e.g., via the one or more sensors 302) of the vehicle 102 (e.g., or the one or more additional vehicles 142) based on the performance (by vehicle 102 (e.g., or the one or more additional vehicles 142)) of the one or more actions matching the vehicle-specific identification pattern. In other words, the infrastructure-side AVM algorithm 112 is configured to perform one or more image recognition techniques on captured image data received from the one or more sensors 302 to determine whether the one or more actions match the vehicle-specific identification pattern.

In one or more examples, and in the instance wherein the vehicle 102 (e.g., or the one or more additional vehicles 142) is located outside the distance-related threshold, the one or more drones 312 are configured to transmit a video stream capturing the performance (by vehicle 102 (e.g., or the one or more additional vehicles 142)) of the one or more actions. As another example, the vehicle 102 (e.g., or the one or more additional vehicles 142) is configured to perform the one or more actions in an instance wherein the vehicle 102 (e.g., or the one or more additional vehicles 142) is determined (e.g., via the vehicle-side AVM algorithm 122) to be within the distance-related threshold from the one or more drones 312. In one or more examples, the distance-related threshold can be any predefined distance from the one or more drones 312 that corresponds to a field of view of the one or more drones 312 and/or a communicative range from the one or more drones 312. As another example, the infrastructure-side AVM algorithm 112 is also configured to perform the one or more image recognition techniques on the video stream received from the one or more drones 312 to determine whether the one or more actions match the vehicle-specific identification pattern. As yet another example, the infrastructure-side AVM algorithm 112 is configured to confirm the identity of the vehicle 102 based on one or more actions matching the vehicle-specific identification pattern. However, it is understood that the one or more drones 312 can determine whether the one or more actions match the vehicle-specific identification pattern themselves.

In one or more examples, the infrastructure-side AVM algorithm 112 is configured to authorize the vehicle 102 (e.g., and/or the one or more additional vehicles 142) in response to confirming the identity of the vehicle 102 (e.g., and/or the one or more additional vehicles 142). As another example, and in a case wherein the vehicle 102 (e.g., and/or the one or more additional vehicles 142) has already been confirmed by the infrastructure-side AVM algorithm 112, the vehicle-side AVM algorithm 112 is also configured to perform one or more means for confirming the identity of the vehicle 102 (e.g., and/or the one or more additional vehicles 142), as is described herein. It is also understood that the one or more drones 312 can authorize the vehicle 102 (e.g., and/or the one or more additional vehicles 142).

In one or more embodiments, and in an instance wherein the identity of the vehicle 102 (e.g., and/or the one or more additional vehicles 142) is confirmed, the vehicle 102 (e.g., and/or the one or more additional vehicles 142) is configured to perform one or more additional actions to demonstrate that the onboarding of the vehicle 102 (e.g., and/or the one or more additional vehicles 142) was successful. As another example, the one or more additional actions performed by the vehicle 102 (e.g., and/or the one or more additional vehicles 142) can be the same actions included within the one or more actions or different actions than the one or more actions.

In one or more embodiments, and in an instance wherein onboarding the vehicle 102 (e.g., and/or the one or more additional vehicles 142) was unsuccessful, other methods of onboarding the vehicle 102 (e.g., and/or the one or more additional vehicles 142) can be implemented such as drone-based authorization (e.g., if infrastructure-based authorization was initially implemented) and/or manual-based authorization.

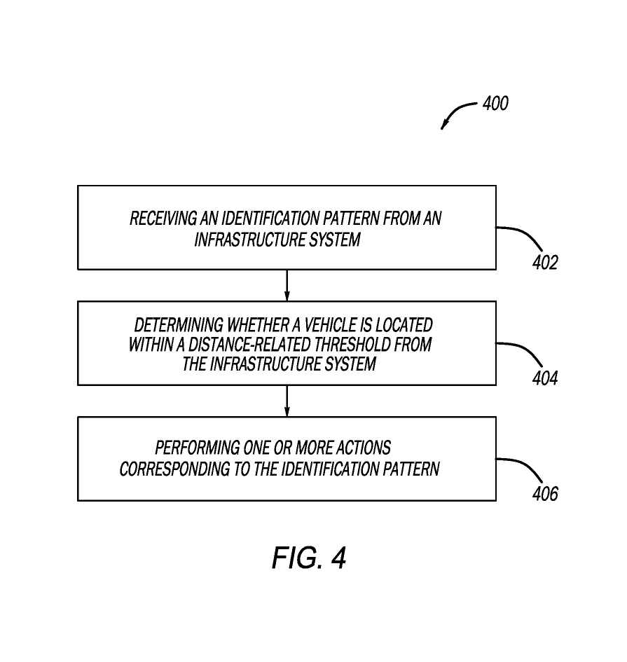

FIG. 4 is a flowchart illustrating an example method 400 for onboarding a vehicle (e.g., the vehicle 102 and/or the one or more additional vehicles 142), as is described herein.

At operation 402, the vehicle is configured to receive an identification pattern from an infrastructure system (e.g., the infrastructure system 110). In one or more examples, the identification pattern includes a light pattern, a vehicle movement, a window movement, a door movement, a hatch movement, an audio pattern, or a combination thereof. As another example, the identification pattern is specific to the vehicle.

At operation 404, the vehicle is also configured to determine (e.g., via the vehicle-side AVM algorithm 122) whether the vehicle is located within a distance-related threshold from the infrastructure system. In one or more examples, the determination of whether the vehicle is located within the distance-related threshold from the infrastructure includes performance (e.g., by the vehicle-side AVM algorithm 122) of one or more localization techniques. As another example, the performance of the one or more localization techniques is based on a predetermined geofenced-based mapping of a marshaling environment.

At operation 406, the vehicle is further configured to perform one or more actions. In one or more examples, the performance of the one or more actions corresponds to the identification pattern. As another example, the one or more actions are performed in response to determining (e.g., by the vehicle-side AVM algorithm 122) that the vehicle is located within the distance-related threshold from the infrastructure system.

In one or more embodiments, the vehicle is additionally configured to cause one or more drones (e.g., the one or more drones 312) to be deployed to the location of the vehicle as well as perform the one or more actions. In one or more examples, the one or more drones are caused to be deployed based on the performance of the one or more localization techniques. As another example, the one or more drones are caused to be deployed in response to determining that the vehicle is located outside of the distance-related threshold from the infrastructure system. As yet another example, the one or more actions are performed in response to the drone being deployed to the location of the vehicle.

In one or more embodiments, the vehicle is configured to perform one or more additional actions. In one or more examples, the one or more additional actions are performed to confirm a successful onboarding event associated with the vehicle. As another example, the one or more additional actions are different than the one or more actions.

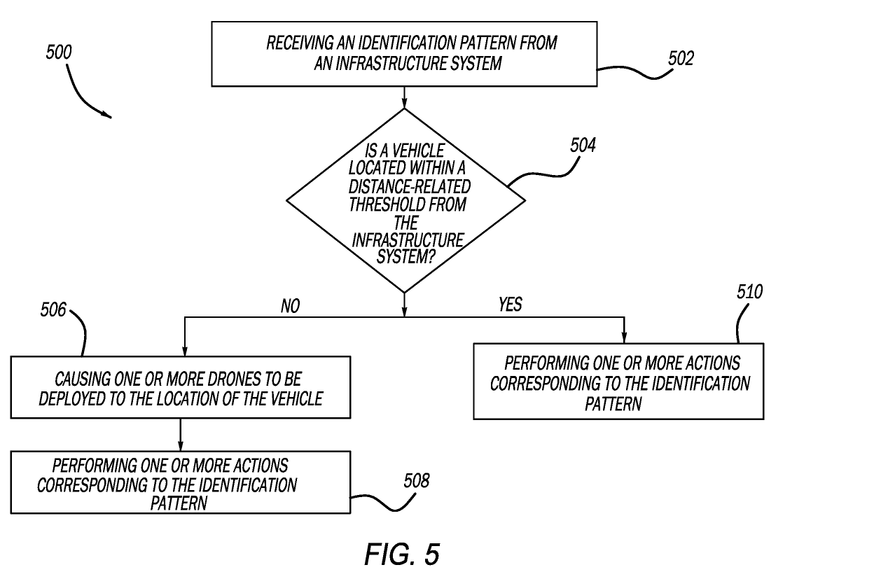

FIG. 5 is a flowchart illustrating another example method 500 for onboarding a vehicle (e.g., the vehicle 102 and/or the one or more additional vehicles 142), as is described herein.

At operation 502, the vehicle is configured to receive an identification pattern from an infrastructure system (e.g., the infrastructure system 110). In one or more examples, the identification pattern includes a light pattern, a vehicle movement, a window movement, a door movement, a hatch movement, an audio pattern, or a combination thereof. As another example, the identification pattern is specific to the vehicle.

At operation 504, the vehicle is also configured to determine (e.g., via the vehicle-side AVM algorithm 122) whether the vehicle is located within a distance-related threshold from the infrastructure system. In an instance wherein the vehicle is determined to not be within the distance-related threshold from the infrastructure system, the vehicle is further configured to cause one or more drones (e.g., the one or more drones 312) to be deployed to the location of the vehicle at operation 506. In one or more examples, the one or more drones are caused to be deployed based on the performance of the one or more localization techniques. Additionally, and in an instance wherein the vehicle is determined to not be within the distance-related threshold from the infrastructure system, the vehicle is also configured to perform the one or more actions in response to the drone being deployed to the location of the vehicle at operation 508.

However, in an instance wherein the vehicle is determined to be within the distance-related threshold from the infrastructure system, the vehicle is configured to perform one or more actions at operation 510. In one or more examples, the performance of the one or more actions corresponds to the identification pattern.

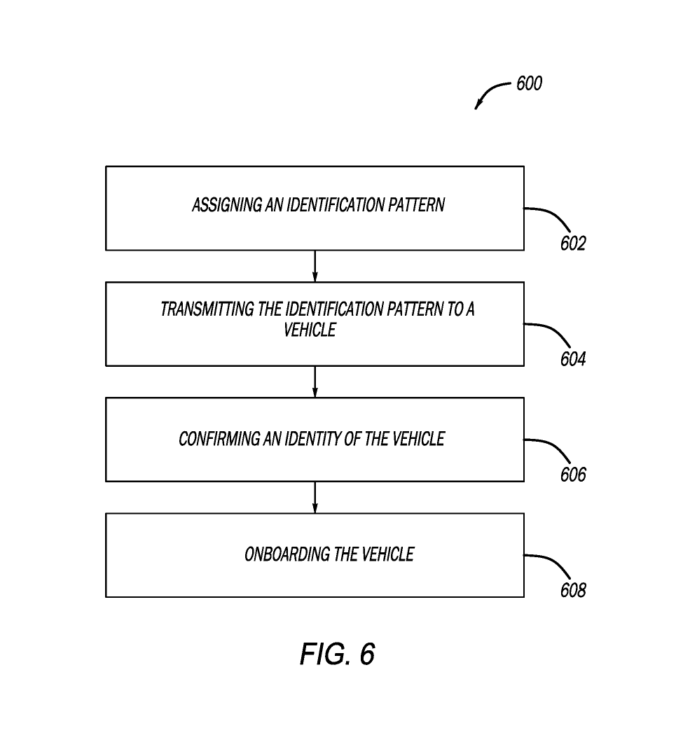

FIG. 6 is a flowchart illustrating yet another example method 600 for onboarding a vehicle (e.g., the vehicle 102 and/or the one or more additional vehicles 142), as is described herein.

At operation 602, an infrastructure system (e.g., the infrastructure system 110) is configured to assign an identification pattern to the vehicle. In one or more examples, the identification pattern is assigned in response to receiving an onboarding request from the vehicle. As another example, the identification pattern includes a light pattern, a vehicle movement, a window movement, a door movement, a hatch movement, an audio pattern, or a combination thereof. As yet another example, the identification pattern is specific to the vehicle.

At operation 604, the infrastructure system is also configured to transmit the identification pattern to the vehicle. At operation 606, the infrastructure system is further configured to confirm an identity of the vehicle. In one or more examples, the identity of the vehicle is confirmed based on the infrastructure system determining that the vehicle is located within a distance-related threshold from the infrastructure system and/or a performance of one or more actions matching the identification pattern. As another example, the one or more actions are performed by the vehicle. As yet another example, the one or more actions are performed in response to receiving (e.g., by the vehicle) the identification pattern.

At operation 608, the infrastructure system is additionally configured to onboard the vehicle. In one or more examples, the vehicle is onboarded in response to the infrastructure system confirming the identity of the vehicle.

In one or more embodiments, the infrastructure system is configured to receive one or more messages from the vehicle as well as deploy one or more drones to a location of the vehicle. In one or more examples, the one or more messages indicate that the vehicle is located outside of the distance-related threshold from the infrastructure system. As another example, the one or more drones are deployed in response to receiving the one or more messages.

In one or more embodiments, the infrastructure system is also configured to receive a video stream, perform one or more image recognition techniques, as well as determine whether the one or more actions match the identification pattern. In one or more examples, the video stream is received from the one or more drones. As another example, the one or more image recognition techniques are performed in response to receiving the video stream. As yet another example, the determination of whether the one or more actions match the identification pattern is executed in response to performing the one or more image recognition techniques. As a further example, the one or more image recognition techniques are performed based on a field of view of one or more sensors (e.g., the one or more sensors 302) of the infrastructure system.

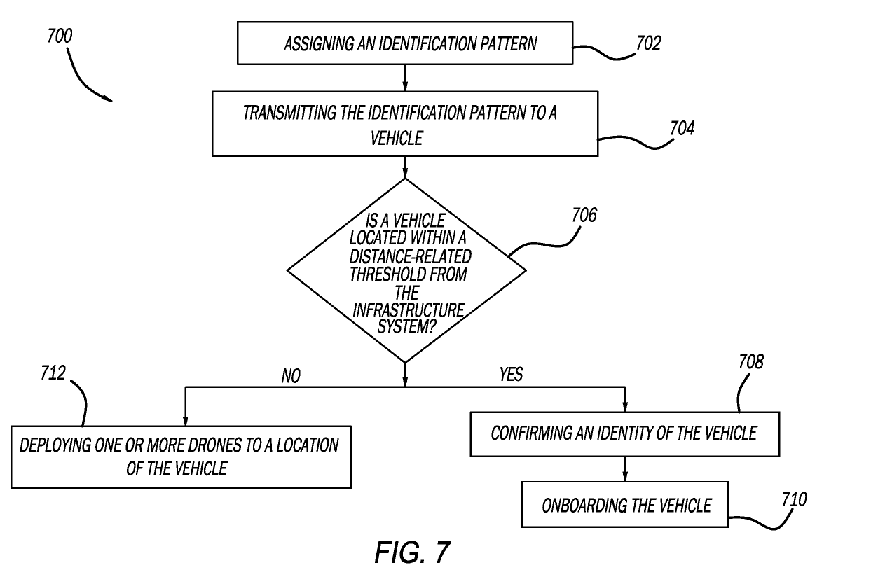

FIG. 7 is a flowchart illustrating a further example method 700 for onboarding a vehicle (e.g., the vehicle 102 and/or the one or more additional vehicles 142), as is described herein.

At operation 702, an infrastructure system (e.g., the infrastructure system 110) is configured to assign an identification pattern to the vehicle. In one or more examples, the identification pattern is assigned in response to receiving an onboarding request from the vehicle. As another example, the identification pattern includes a light pattern, a vehicle movement, a window movement, a door movement, a hatch movement, an audio pattern, or a combination thereof. As yet another example, the identification pattern is specific to the vehicle.

At operation 704, the infrastructure system is also configured to transmit the identification pattern to the vehicle. At operation 706, the infrastructure system is further configured to determine (e.g., via the infrastructure-side AVM algorithm 112) whether the vehicle is located within a distance-related threshold from the infrastructure system. In an instance wherein the vehicle is determined to be within the distance-related threshold from the infrastructure system, the infrastructure system is configured to confirm an identity of the vehicle at operation 708. In one or more examples, the identity of the vehicle is confirmed based on the infrastructure system determining that the vehicle is located within a distance-related threshold from the infrastructure system and/or a performance of one or more actions matching the identification pattern. As another example, the one or more actions are performed by the vehicle. As yet another example, the one or more actions are performed in response to receiving (e.g., by the vehicle) the identification pattern. Additionally, and in an instance wherein the vehicle is determined to be within the distance-related threshold from the infrastructure system, the infrastructure system is also configured to onboard the vehicle at operation 710. In one or more examples, the vehicle is onboarded in response to the infrastructure system confirming the identity of the vehicle.

However, in a case wherein the vehicle is determined to not be within the distance-related threshold from the infrastructure system, the infrastructure system is configured to deploy one or more drones to a location of the vehicle at operation 712. In one or more examples, the one or more drones are deployed in response to receiving one or more messages from the vehicle indicating that the vehicle is located outside of the distance-related threshold from the infrastructure system.

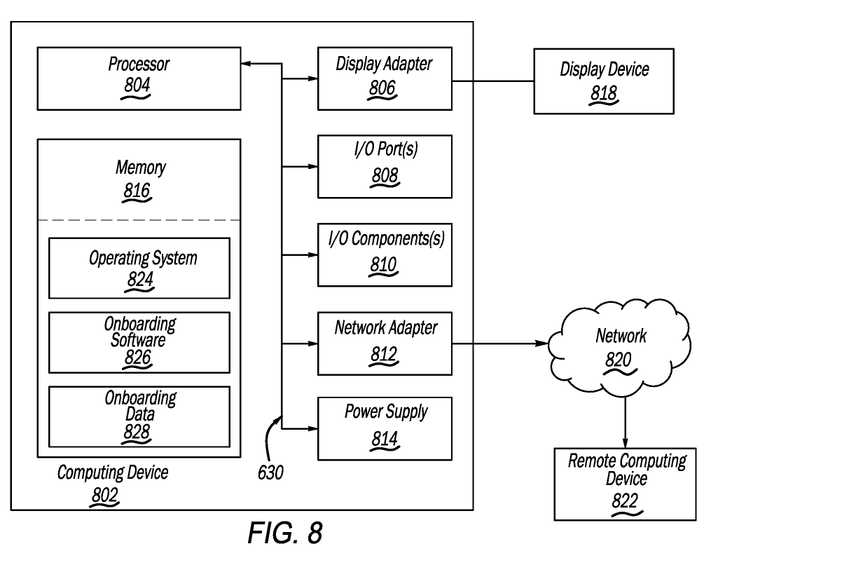

FIG. 8 illustrates an operating environment, such as a computer system, that facilitates the performance of the one or more systems and methods described herein. More specifically, the systems and methods described herein can be implemented using a computing device 802. For example, the computing device 802 can be a personal computer, a desktop, a laptop, a tablet, a hand-held computer, a server, a workstation, a mainframe, a wearable computer, a supercomputer, or a combination thereof. However, it is understood that the aforementioned examples of the computing device 802 is non-exhaustive and the computing device 802 can be any type of processing or computing device. The computing device 802 generally includes a processor 804, a display adapter 806, one or more input/output port(s) 808, one or more input/output component(s) 810, a network adapter 812, a power supply 814, and a memory 816. However, it is understood that the computing device 802 can include any additional components therein and is not required to include any of the listed components (e.g., the processor 804, the display adapter 806, the one or more input/output port(s) 808, the one or more input/output component(s) 810, the network adapter 812, the power supply 814, and the memory 816).

The processor 804 is configured to provide instructions to the computing device 802 so that the computing device 802 can process one or more tasks including the implementation of a software program to perform one or more operations as described in more detail herein. It is also understood that the computing device 802 may include any number or processors 804 therein. The display adapter 806 can be a graphics card or a video board that provides the computing device 802 with a capability to display content on a display device 818. For example, the display device 818 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 818 is non-exhaustive and that the display device 818 can be any type of device capable of providing a visual display.

The input/output port(s) 808 provide a number of interfaces (e.g., sockets) for one or more cables to connect to the computing device 802. It is understood that there may be any number of input/output port(s) 808 on the computing device 802. For example, the input/output port(s) 808 provides a means for the computing device 802 to receive signals and/or data from an external device connected to the computing device 802 via the one or more cables. As another example, the input/output port(s) 808 provide a means for the computing device 802 to send signals and/or data to an external device connected to the computing device 802 via the one or more cables. The input/output component(s) 810 can include one or more components that support the input/output port(s) 808 such as, but not limited to, a switch, a push button, a pressure mat, a float switch, a keypad, a radio receive, or a combination thereof.

The network adapter 812 can be any type of network interface controller that is configured to provide a means for communicating over a network 820 with another computing device, such as a remote computing device 822. For example, the remote computing device 822 can be a user device such as a cellular-phone, a smartphone, a tablet, a laptop, or a combination thereof. The power supply 814 is configured to convert alternating high voltage current (e.g., AC) into direct current (e.g., DC) to provide power to the other components (e.g., the processor 804, the display adapter 806, the one or more input/output port(s) 808, the one or more input/output component(s) 810, the network adapter 812, and the memory 816) of the computing device 802.

Additionally, the memory 816 can be a mass storage device and/or a system memory such as a hard disk drive, a memory card, a solid-state drive, random access memory (RAM), or a combination thereof. The memory 816 is configured to provide storage for instructions and data associated with the operation of the computing device 802. The memory 816 can generally include an operating system 824, onboarding software 826, and onboarding data 828. For example, the operating system 824 is configured to manage and/or process any of the data and/or instructions associated with the onboarding software 826 and/or onboarding data 828, as described in more detail herein, such as to onboard one or more vehicles.

Furthermore, a system bus 830 is also included within the computing device 802 that is configured to couple each of the various components (e.g., the processor 804, the display adapter 806, the one or more input/output port(s) 808, the one or more input/output component(s) 810, the network adapter 812, the power supply 814, and the memory 816) of the computing device 802. It is also understood that each of the components of the computing device 802, and the functionality associated with each of the components of the computing device 802, may be implemented within the remote computing device 822. While the operating environment illustrated within FIG. 8 depicts a particular configuration associated with at least the computing device 802, the network 820, and the remote computing device 822, it is understood that the operating environment may be configured in any way.

Thus, one or more examples of the present disclosure provide a means for onboarding a vehicle based on the implementation of a fully customizable and vehicle-specific pattern that, if recognizable by a central server (e.g., the infrastructure system 110) and/or a drone (e.g., the one or more drones 312), the vehicle can be accurately onboarded within a marshaling system.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for onboarding a vehicle, the method comprising:
receiving, at the vehicle, an identification pattern from an infrastructure system;
determining whether the vehicle is located within a distance-related threshold from the infrastructure system; and
performing one or more actions corresponding to the identification pattern in response to determining that the vehicle is located within the distance-related threshold from the infrastructure system.

2. The method of claim 1, wherein the identification pattern includes a light pattern, a vehicle movement, a window movement, a door movement, a hatch movement, an audio pattern, or a combination thereof.

3. The method of claim 1, wherein the identification pattern is specific to the vehicle.

4. The method of claim 1, wherein determining whether the vehicle is located within the distance-related threshold from the infrastructure system further comprises:
performing one or more localization techniques based on a predetermined geofenced-based mapping of a marshaling environment.

5. The method of claim 4, further comprising:
causing, based on performing the one or more localization techniques, one or more drones to be deployed to the location of the vehicle in response to determining that the vehicle is located outside of the distance-related threshold from the infrastructure system; and
performing the one or more actions in response to the one or more drones being deployed to the location of the vehicle.

6. The method of claim 1, further comprising:
performing one or more additional actions to confirm a successful onboarding event associated with the vehicle, wherein the one or more additional actions are different than the one or more actions.

7. A method for onboarding a vehicle, the method comprising:
assigning, to the vehicle, an identification pattern in response to receiving an onboarding request from the vehicle;
transmitting the identification pattern to the vehicle;
confirming an identity of the vehicle based on determining that the vehicle is located within a distance-related threshold from an infrastructure system and a performance of one or more actions matching the identification pattern, wherein the one or more actions are performed by the vehicle in response to receiving the identification pattern; and
onboarding the vehicle in response to confirming the identity of the vehicle.

8. The method of claim 7, wherein the identification pattern includes a light pattern, a vehicle movement, a window movement, a door movement, a hatch movement, an audio pattern, or a combination thereof.

9. The method of claim 7, wherein the identification pattern is specific to the vehicle.

10. The method of claim 7, further comprising:
receiving, from the vehicle, one or more messages indicating that the vehicle is located outside of the distance-related threshold from the infrastructure system; and
deploying one or more drones to a location of the vehicle in response to receiving the one or more messages.

11. The method of claim 10, further comprising:
receiving a video stream from the one or more drones;
performing one or more image recognition techniques in response to receiving the video stream; and
determining whether the one or more actions match the identification pattern in response to performing the one or more image recognition techniques.

12. The method of claim 7, further comprising:
performing one or more image recognition techniques based on a field of view of one or more sensors of the infrastructure system; and
determining whether the one or more actions match the identification pattern in response to performing the one or more image recognition techniques.

13. A system for onboarding a vehicle, the system comprising:
a vehicle system configured to:
transmit an onboarding request,
receive an identification pattern specific to the vehicle,
determine whether the vehicle associated with the vehicle system is located within a distance-related threshold from an infrastructure system, and
perform one or more actions corresponding to the identification pattern in response to determining that the vehicle is located within the distance-related threshold from the infrastructure system; and
the infrastructure system configured to:
assign the identification pattern to the vehicle in response to receiving the onboarding request,
transmit the identification pattern,
confirm an identity of the vehicle based on the performance of the one or more actions matching the identification pattern, and
onboard the vehicle in response to confirming the identity of the vehicle.

14. The system of claim 13, wherein the identification pattern includes a light pattern, a vehicle movement, a window movement, a door movement, a hatch movement, an audio pattern, or a combination thereof.

15. The system of claim 13, wherein the vehicle system configured to determine whether the vehicle is located within the distance-related threshold from the infrastructure system is further configured to:
perform one or more localization techniques based on a predetermined geofenced-based mapping of a marshaling environment.

16. The system of claim 15, wherein the vehicle system is further configured to:
cause, based on the performance of the one or more localization techniques, one or more drones to be deployed to the location of the vehicle in response to determining that the vehicle is located outside of the distance-related threshold from the infrastructure system; and
perform the one or more actions in response to the one or more drones being deployed to the location of the vehicle.

17. The system of claim 13, wherein the infrastructure system is further configured to:
receive, from the vehicle system, one or more messages indicating that the vehicle is located outside of the distance-related threshold from the infrastructure system; and
deploy one or more drones to a location of the vehicle in response to receiving the one or more messages.

18. The system of claim 17, wherein the infrastructure system is further configured to:
receive a video stream from the one or more drones;
perform one or more image recognition techniques in response to the receipt of the video stream; and
determine whether the one or more actions match the identification pattern in response to the performance of the one or more image recognition techniques.

19. The system of claim 13, wherein the infrastructure system is further configured to:
perform one or more image recognition techniques based on a field of view of one or more sensors of the infrastructure system; and
determine whether the one or more actions match the identification pattern in response to the performance of the one or more image recognition techniques.

20. The system of claim 13, wherein the vehicle system is further configured to:
perform one or more additional actions to confirm a successful onboarding event associated with the vehicle, wherein the one or more additional actions are different than the one or more actions.
